(19) United States
(12) Patent Application Publication
(10) Pub. No.: US 2010/0099315 A1
(43) Pub. Date: Apr. 22, 2010

(54) TEXTILE SUBSTRATE INCORPORATING A HEAT REGULATION COMPOSITION ENCOMPASSING TRANSFER BLOCKS

(75) Inventor: Claudine Colin, Charly (FR)

Correspondence Address: BACHMAN & LAPOINTE, P.C., 900 CHAPEL STREET, SUITE 1201, NEW HAVEN, CT, 06510, US

(73) Assignee: LAINIERE DE PICARDIE, Peronne Cedex (FR)

(21) Appl. No.: 12/522,583

(22) PCT Filed: Jan. 9, 2008
(86) PCT No.: PCT/FR2008/000024

§ 371 Date: Jul. 9, 2009

(30) Foreign Application Priority Data
Jan. 10, 2007 (FR) 0700166

(51) Int. Cl. B32B 5/16; B05D 3/06

(52) U.S. Cl. 442/74; 427/532

(57) ABSTRACT

A textile substrate containing fibres is provided, which substrate includes a thermal regulation composition. The substrate is characterized in that it further comprises islands of a material which are associated with the fibres in order to be surrounded by the thermal regulation composition. The island-forming material is capable of enhancing the heat and/or humidity transfer in the thermal regulation composition. A method for producing such a textile substrate is described.

### BACKGROUND

(1) Field of the Invention

The invention relates to a textile substrate incorporating a heat regulation composition, and a method to manufacture such a textile substrate.

(2) Prior Art

In order to give a textile substrate heat regulation properties, it is known to use a heat regulation composition which comprises microcapsules incorporating a phase change material composition. Indeed, by means of the absorption—restitution of heat energy during phase changes of the material, the textile substrate makes it possible to delay temperature changes so as to provide thermal comfort.

To incorporate said microcapsules into a textile substrate, it is particularly known to integrate same in the fibres (see, in particular, the document EP-0 306 202), arrange same in a polymer binder layer which is coated on the textile substrate (see, in particular, the document EP-0 611 330), or fix same to the fibres individually (see, in particular, the document EP-1 275 769).

However, in all these embodiments, the problem arises of optimising the thermal comfort provided by the heat regulation composition. In particular, said thermal comfort is dependent of the heat transfer rate and distribution in the heat regulation composition. Furthermore, the transfer rate of moisture via the heat regulation composition is also a relevant factor in terms of the perceived thermal comfort.

### SUMMARY OF THE INVENTION

The aim of the invention is to remedy the problems of the prior art by proposing a textile substrate incorporating a heat regulation composition, wherein heat and/or moisture transfers are optimised to enhance the perceived thermal comfort.

To this end, according to a first embodiment, the invention proposes a textile substrate comprising fibres, said substrate incorporating a heat regulation composition, said substrate also comprising material blocks which are associated with the fibres so as to be encompassed by the heat regulation composition, the material forming the blocks being capable of promoting the transfer of heat and/or moisture in the heat regulation composition.

According to a specific embodiment, the heat regulation composition comprises microcapsules provided with an envelope wherein a phase change material is arranged, the melting point of said material being arranged to ensure heat regulation, the microcapsules being associated with the fibres by means of bridging.

According to a second embodiment, the invention proposes a method to manufacture such a textile substrate, said method comprising steps consisting of:
preparing a microcapsule formulation containing the phase change material in an envelope, said envelope being based on a material comprising a type of reactive group in ionising radiation, said formulation also comprising at least one bridging agent having two types of reactive groups in ionising radiation;
preparing a material capable of promoting the transfer or heat and/or moisture;
applying the material on at least one zone of the surface of the textile substrate so as to form blocks associated with the fibres; and
impregnating the textile substrate with the microcapsule formulation; and
applying ionising radiation on the impregnated textile substrate so as to couple the microcapsules on said substrate by reacting the reactive groups.

Other specificities and advantages of the invention will emerge in the description hereinafter of various specific embodiments.

### DETAILED DESCRIPTION OF THE PREFERRED EMBODIMENT(S)

The invention relates to a textile substrate comprising fibres, said substrate being of any possible type, particularly knitted, woven or comprising a non-woven lap. In one example of an embodiment, the textile substrate comprises a non-woven lap weighing less than 50 g/m², particularly between 30 and 80 g/m², and less than 0.5 mm thick. The length of the fibres of the lap may be between and 60 mm. The lap may be bound by means of water injection or any other means making it possible to obtain a resistant and absorbent lap (interlocking, chemical binding with suitable binder, thermal binding).

In particular, the textile substrate is based on hydrophilic fibres having a titre less than 4 dtex, so as to promote flexibility along with, as seen hereinafter in the description, the absorption capacity of an aqueous microcapsule formulation.

In particular, the fibres may be based on polyester or polyamide. In an alternative embodiment, it is possible to envisage a mixture of polyester or polyamide fibres and cellulose fibres, particularly cotton or viscose, for example in a proportion by weight of 80%/20%.

The textile substrate according to the invention incorporates a heat regulation composition. The heat composition may comprise a phase change material wherein the melting point is between 15° C. and 38° C., preferentially between 22° C. and 35° C., so as to ensure heat regulation in the vicinity of human body temperature.

Using a known method, such a composition may be based on paraffin, particularly comprising between 16 and 22 carbon atoms according to the desired melting point. In this way, when the ambient temperature increases, the liquefaction of the composition enables an absorption of heat energy at quasi-constant temperature and, when the ambient temperature decreases, the solidification of said composition restores said heat energy. In an alternative embodiment, it is possible to use fire-proof phase change materials not containing paraffins, particularly for non-fire applications.

According to one embodiment, the heat regulation composition comprises microcapsules less than 20 μm in size, particularly between 1 and 10 μm on average. The microcapsules are provided with an envelope wherein the phase change material is arranged. Using a known method, the microcapsules may be integrated in the fibres, arranged in a layer of polymer binder which is coated on the textile substrate, or fixed with the fibres individually.

The heat regulation formulation may comprise two types of microcapsules, the phase change materials of each of the types of microcapsules differing by the melting point thereof. In particular, both types of microcapsules may be those referenced Lurapret TX PMC 28 and Lurapret TX PMC 35 produced by BASF, which have a melting point of 28° C. and 35° C., respectively. For this purpose, the phase change material is n-Octodecane and n-Eicosane, respectively, the calorie storage or restitution capacity being of the order of 170 J/g. Furthermore, the envelope of said microcapsules is based on polymethylmethacrylate (PMMA).

The substrate also comprises material blocks which are associated with the fibres to be encompassed, at least partially, by the heat regulation composition, the material forming the blocks being capable of promoting the transfer of heat and/or moisture in the heat regulation composition. In this way, the blocks promote exchanges of heat and/or moisture in the heat regulation composition so as to enhance the thermal comfort provided. In particular, the exchanges are essentially carried out by means of conduction, by envisaging that the blocks are in contact, or at least in the immediate vicinity, of the regulation composition.

If the heat regulation composition comprises microcapsules, the blocks promote the transfer of heat between same so as to enhance the heat energy absorption, or restitution, kinematics by the phase change material.

According to one embodiment, the blocks are formed with a hygroscopic polymer material base, particularly selected in the group comprising Polyvinyl alcohol (PVA), cellulose derivatives, cellulose Carboxy Methyl, Chitosan, Chitin derivatives.

Moreover, the blocks may also contain microcapsules which are coated in the material, said microcapsules integrating an active substance. The active substance may also be a phase change material enhancing heat regulation, or have other functions, for example hygienic or comfort-related. In examples of embodiments, the active substance may comprise essential oils, particularly to improve breathing, fragrances, repellents, particularly against mosquitoes, conductive or antistatic charges, bacteriostatic agents such as silver salts, anti-odour agents. In addition, Chitosan provides a bacteriostatic function in addition to hygroscopy.

According to one embodiment, the blocks are arranged on at least one surface of the textile substrate, in the form of a discrete network of geometric zones, for example in the form of a two-dimensional network of points having a rectangular or other shape. Advantageously, the blocks may cover 5% and 40% of the surface of the textile substrate whereon they are arranged.

Moreover, the blocks may form or comprise a visible mark or logo on one face of the textile substrate, for example by incorporating a pigment in the materials forming same.

The textile substrate may be used to fashion a textile article, particularly for bed linen such as pillows, quilts, or for clothing, particularly for sports or work.

In particular, the textile article may comprise, on one side of a textile substrate, an inner textile layer and, on the other side of said substrate, an outer textile layer which is arranged to capture an air volume, such as a cotton wadding layer. In this way, by arranging the inner layer facing the body, the heat regulation function is optimised. Moreover, the textile article may also comprise a waterproof/breathable layer, for example hydrophilic or porous hydrophobic, which is arranged on the outer textile layer so as to allow the body to breathe by preventing liquid water from reaching same.

A method to manufacture a textile substrate according to the invention is described below, wherein the microcapsules are associated with the fibres by means of bridging between the envelope thereof and the fibres of said substrate. In addition, the textile substrate may incorporate more than 10 g/m², particularly more than 40 g/m², of microcapsules so as to enable the absorption and restitution from 5 to more than 150 J/g of heat energy.

The method envisages preparing a microcapsule formulation containing the phase change material in an envelope, said envelope being based on a material comprising a reactive group type in ionising radiation. In particular, such groups may comprise an unsaturated bond which, under the effect of ionising radiation, forms a reactive free radical. In examples of embodiments, the reactive groups in ionising radiation are selected in the group comprising hydroxyl, carboxyl, carbonyl, acrylate, methacrylate, amine, amide, imide, urethane, styrene groups. In an alternative embodiment, the envelope may comprise several types of reactive groups in ionising radiation.

The microcapsule formulation also comprises at least one bridging agent having two types of reactive groups in ionising radiation, said types optionally being identical or different. In addition, at least some reactive groups may be selected to be thermally reactive.

More specifically, the microcapsule formulation may comprise a mixture of bridging agents, particularly selected in the group comprising glycidyl acrylate or methacrylate (AGLY, MAGLY), polyethylene glycol 200, 400, 600 diacrylates (PEG200 DA, PEG400 DA, PEG600 DA), dipropylene glycol diacrylate (DPGDA), potassium sulphopropyl methacrylate (SPMK) and lauryl methacrylate or acrylate.

In particular, AGLY or MAGLY is a bifunctional bridging agent having an epoxy group and acrylate or methacrylate group and PEG DAs are bifunctional internal plasticising agents which contribute to bridging by extending the bond chains between the microcapsules and the fibres. Therefore, the combined use of both types of bridging agents makes it possible to enhance the flexibility of the microcapsule deposition.

The mass ratio between the bridging agent(s) and the microcapsules is preferentially less than 0.5, particularly between 0.10 and 0.30.

Moreover, the microcapsule formulation may comprise between 30% and 60% by weight, particularly between 40% and 50% by weight, microcapsules dispersed in a solvent, particularly in water. The microcapsule formulation may also comprise at least one agent enhancing the stability of the dispersion, for example sulphopropyl methacrylate (SPM) or sulphopropyl acrylate (SPA) which are anionic monomers reactive in ionising radiation, or an acrylic latex such as that sold under the brand name HYCAR 26319 which enhances the wetting of the microcapsules by the bridging agents while creating bridges between the microcapsules and the substrate. In an alternative embodiment, said agent may be a polyacrylate in gel form or a polyurethane dispersion.

The functionalisation method also comprises a preparation step of a material capable of promoting the transfer or heat and/or moisture, followed by an application step of the material on at least one zone of the surface of the textile substrate so as to form blocks associated with the fibres.

According to the embodiment described, the material forming the blocks also displays tightness to the microcapsule formulation so as to, as described hereinafter, prevent the subsequent impregnation of the blocks with the microcapsule formulation. In this way, it is possible to enhance the flexibility of the textile substrate, in that the zones devoid of microcapsules may form preferential folding zones of said substrate.

For this purpose, the material forming the blocks is based on at least partially hydrolysed polyvinyl alcohol (PVA) which is dissolved in water, said solution also comprising an anti-adherent agent for the microcapsule formulation. For example, the anti-adherent agent may be a glycerol and the viscosity of the material is envisaged to trap the anti-adherent agent to prevent the migration thereof. In particular, the material may be thixotropic and display a viscosity between 50 and 300 dPA·s so as enable application in paste form with migration via the textile substrate to coat the fibres.

The material forming the blocks may be applied by means of serigraphy, followed by at least partial drying of said material before impregnation of the textile substrate with the microcapsule formulation. The quantity of material deposited may be between 5 and 40 g/m².

The method then envisages impregnating the textile substrate with the microcapsule formulation. The impregnation may be performed by means of padding, the conditions of said padding and the features of the textile substrate being adapted to lift at least 80% and preferentially at 150% by weight of microcapsule formulation in said textile substrate. In this way, by combining a formulation with a very high microcapsule content and a high lift rate, it is possible, by means of the different reactive groups, to fix a large quantity of microcapsules in the textile substrate.

In particular, the microcapsule formulation may be thixotropic and the viscosity thereof between 130 and 150 mPa·s, particularly by adding a liquefier to said formulation, such as isopropanol. In addition, with a textile substrate based on hydrophilic fibres, it is possible to obtain good wetting and a satisfactory rise of the formulation in the textile substrate during impregnation. In addition, the textile substrate may undergo, prior to the impregnation thereof, specific treatments, particularly to enhance the cohesion and/or wettability thereof.

Moreover, the calendaring pressure during padding is relatively low, particularly of the order of 1 to 2 bar, to enable a high lift with homogeneous penetration and distribution of the microcapsule formulation in the textile substrate. In an example of an embodiment, the quantity of formulation impregnated in the textile substrate having a mass per unit area of 50 g/m² may be greater than 50 g/m², particularly between 50 g/m² and 150 g/m².

After impregnation, the textile substrate may be dried, particularly by means of infrared lamps, before the application of ionising radiation on the impregnated textile substrate. The drying also enables heat setting of the microcapsule formulation in the textile substrate. In an alternative embodiment, the heat setting may be performed after the application of the ionising radiation, for example at a temperature between 100 and 140° C., to complete the setting of the microcapsules by means of reactions of the thermally reactive bridging agents.

The power and duration of the radiation are arranged to activate the reactive groups so as to ensure the bridging of the microcapsules on said substrate. According to one embodiment, the ionising radiation is an ion bombardment generated by an electron accelerator, which may be performed in one or two passages, particularly in one passage on either side of the textile substrate. Moreover, the power of the ionising radiation combined with the presence of the various reactive groups makes it possible to fix a large quantity of microcapsules in the textile substrate.

In addition, the reactions between the reactive groups of the envelope and the bridging agents make it possible to bind the envelope of the microcapsules with the fibres, the microcapsules together and, optionally, the bridging agents together, so as to create a solid three-dimensional network resistant to friction and to washing or dry cleaning.

Finally, the textile substrate may be washed and dried or undergo other treatments necessary for the subsequent use thereof.

1-17. (canceled)

18. A textile substrate comprising a plurality of fibres, said substrate incorporating a heat regulation composition, said substrate also comprising material blocks which are associated with the fibres so as to be encompassed by the heat regulation composition, and the said material blocks being formed from a material capable of promoting the transfer of heat and/or moisture in the heat regulation composition.

19. The textile substrate according to claim 18, wherein the blocks are formed with a hydroscopic polymer material base.

20. The textile substrate according to claim 19, wherein the hygroscopic polymer material is selected from the group consisting of Polyvinyl alcohol (PVA), cellulose derivatives, cellulose Carboxy Methyl, Chitosan, and Chitin derivatives.

21. The textile substrate according to claim 18, wherein the blocks contain microcapsules which are coated in the material, and said microcapsules integrating an active substance.

22. The textile substrate according to claim 18, wherein the blocks are arranged on at least one surface of the textile substrate in the form of a discrete network of geometric zones.

23. The textile substrate according to claim 22, wherein the blocks cover between 5% and 40% of the at least one surface of the textile substrate whereon they are arranged.

24. The textile substrate according to claim 18, wherein the fibres are hydrophilic.

25. The textile substrate according to claim 18, wherein said substrate comprises a non-woven lap.

26. The textile substrate according to claim 18, wherein the heat regulation composition comprises microcapsules provided with an envelope wherein a phase change material is arranged, and a melting point of said phase change material being arranged to ensure heat regulation.

27. The textile substrate according to claim 26, wherein the heat regulation composition comprises two types of microcapsules, with the phase change materials of each of the types of microcapsules differing by the melting point thereof.

28. The textile substrate according to claim 26, wherein said substrate incorporates more than 10 g/m² of said microcapsules.

29. The textile substrate according to claim 26, wherein the microcapsules are associated with the fibres by means of bridging.

30. A method to manufacture a textile substrate according to claim 29, said method comprising steps consisting of:
preparing a microcapsule formulation containing the phase change material in an envelope, said envelope being based on a material comprising a type of reactive group in ionising radiation, said formulation also comprising at least one bridging agent having two types of reactive groups in ionising radiation;
preparing a material capable of promoting the transfer or heat and/or moisture;
applying the material on at least one zone of the surface of the textile substrate so as to form blocks associated with the fibres;
impregnating the textile substrate with the microcapsule formulation; and
applying ionising radiation on the impregnated textile substrate so as to couple the microcapsules on said substrate by reacting the reactive groups.

31. The method according to claim 30, wherein the material applying step comprises applying a material which displays tightness to the microcapsule formulation so as to prevent the subsequent impregnation of the blocks with the microcapsule formulation.

32. The method according to claim 30, wherein the impregnating step is performed by means of padding, the conditions of said padding and the features of the textile substrate being adapted to lift at least 80% by weight of microcapsule formulation in said textile substrate.

33. The method according to claim 31, further comprising basing the material forming the blocks on at least partially hydrolysed polyvinyl alcohol (PVA) which is dissolved in water, and said solution also comprising an anti-adherent agent for the microcapsule formulation.

34. The method according to claim 30, further comprising applying the material of the blocks by means of serigraphy, followed by at least partial drying of said material before impregnation of the textile substrate with the microcapsule formulation.
